(19) United States
(12) Patent Application Publication
(10) Pub. No.: US 2026/0256044 A1
(43) Pub. Date: Sep. 3, 2026

(54) SYSTEMS AND METHODS FOR AGRICULTURAL ADDITIVE DELIVERY

(71) Applicant: Loam Bio Pty Ltd, Orange (AU)

(72) Inventors: Tegan NOCK, Orange (AU); Guy WEBB, Orange (AU); David Lloyd NOCK, Orange (AU)

(21) Appl. No.: 18/881,716

(22) PCT Filed: Jul. 6, 2023
(86) PCT No.: PCT/IB2023/056975

§ 371 Date: Jan. 6, 2025

Related U.S. Application Data
(60) Provisional application No. 63/367,813, filed on Jul. 6, 2022.

(51) Int. Cl. A01C 1/06; A01C 7/06; A01C 7/08; A01C 7/10; A01C 15/00

(52) U.S. Cl. CPC A01C 1/06; A01C 7/06; A01C 7/081; A01C 7/102; A01C 15/006

(57) ABSTRACT

An agricultural additive dispenser system for delivering an agricultural additive to a stream of air flowing through an air seeder cart includes at least a housing, rotational meter, and a motor for rotating the meter.

### CROSS-REFERENCE TO RELATED APPLICATIONS

This application claims the priority benefit of U.S. Provisional Patent Application No. 63/367,813, filed Jul. 6, 2022, the entire contents of which are incorporated by reference herein.

### FIELD

This disclosure relates generally to air seeder systems and methods, and more specifically to the delivery of agricultural additives.

### BACKGROUND

The delivery of agricultural products including seed and/or fertilizer to soil furrows during planting commonly involves the use of an air seeder system. By metering agricultural products into the air stream of an air seeder cart, products can be added to the soil in an automated and uniform manner. However, the delivery of agricultural additives including, for example, biological inoculums poses a challenge as required dosages are commonly lower than those of seed and/or fertilizer, and can be less than 5 kilograms of agricultural additive per hectare of land. These additives can be important for the growth of crops, for the maintenance of soil, and/or for the benefit of the larger agroecosystem, and need to be delivered uniformly in the vicinity of seeds in the soil furrow to maximize their potential.

Conventional techniques for delivery of low-volume agricultural additives include the direct application of additive onto seed and/or fertilizer prior to the distribution of the seed and/or fertilizer by means of, for example, an air seeder cart. However, the application of additive directly onto seed and/or fertilizer introduces several challenges. First, often only a small amount of additive is needed and must uniformly coat seed and/or fertilizer granules, and/or mix uniformly with the seed and/or fertilizer powder to maximize its effectivity. When adding additive directly to seed and/or fertilizer, the coating and/or mixing commonly occurs before seed and/or fertilizer is added to the air seeder system, when the seed and/or fertilizer is flowing in bulk through an auger tube toward a hopper. Thus, creating a uniform coating of more than the top layer of seed and/or fertilizer poses a challenge. Second, many additives including those with a live bacterial, fungal, and/or microbial inoculums are temperature-sensitive—applying them to seed and/or fertilizer even several hours before delivering to the soil without thermal management risks spoiling the additive. Finally, the systems and methods used to deliver seed and/or fertilizer to a hopper, and to coat the seed and/or fertilizer with additive are often not standardized, varying from farming operation to farming operation. This lack of standardized additive delivery can introduce complexity and increase batch-to-batch variability.

### SUMMARY

Disclosed herein are systems and methods for the delivery of low-volume agricultural additives directly to the air stream of an air seeder cart, allowing mixing and/or coating of the seed and/or fertilizer with the low-volume additive, thereby improving low-volume additive delivery uniformity. The systems and methods may include the storage of additive in an optionally insulated container placed within a cold storage unit before installation onto the air seeder cart, thereby reducing the likelihood that the additive will spoil before reaching the soil. The systems and methods may further include the retrofitting of agricultural additive dispenser systems onto pre-existing air seeder carts, enabling a standardized means of delivering agricultural additives.

According to an aspect, an agricultural additive dispenser system for delivering an agricultural additive to a stream of air flowing through an air seeder cart toward one or more soil furrows includes a housing for housing the agricultural additive; a rotational meter connected to the base of the housing to control a delivery rate of the agricultural additive exiting the housing; and a motor connected to the meter for rotating the meter, wherein the motor can be controlled in correspondence with a movement speed of the air seeder cart such that a delivery rate of the additive into the one or more soil furrows is 5 kilograms or less of agricultural additive per hectare of land.

Optionally, the housing can comprise a sensor for measuring the volume of agricultural additive contained within the housing.

Optionally, the housing is configured for housing a sealed container that contains the additive, and the housing houses a seal-breaking mechanism for breaking a seal of the sealed container. Optionally, the container is thermally insulated. Optionally, the dispenser system can comprise a container-locking mechanism configured to mount and seal the container to the housing.

Optionally, the housing is configured for directly adding the additive into the housing.

Optionally, the surface finish of the housing is selected to minimize the accumulation of static charges on the surface of the housing.

Optionally, the material properties of the housing are selected to minimize the accumulation of static charges on the surface of the housing.

Optionally, the material of the housing is conductive.

Optionally, the housing is grounded.

Optionally, the agricultural additive comprises one or more microbial inoculums. Optionally, the one or more microbial inoculums comprise seaweed extracts, plant extracts, biochar, and/or compost.

Optionally, the agricultural additive comprises one or more inorganic soil additives.

Optionally, the agricultural additive comprises powder and/or granules. Optionally, the ratio of powder to granules is selected to minimize disruptions to the flow of additive through the rotational meter. Optionally, the ratio of powder to granules is selected to minimize the accumulation of static charges on the surface of the housing.

Optionally, the rotational meter comprises a wheel.

Optionally, the rotational meter comprises an auger.

Optionally, the rotational meter comprises a worm gear.

Optionally, the dispenser system further comprises a controller configured to receive a signal corresponding to the movement speed of the air seeder cart and to control the rotational velocity of the motor based on the signal.

Optionally, the dispenser system is configured to be retrofit onto an air seeder cart.

According to an aspect, an agricultural additive dispenser system for delivering an agricultural additive to a stream of air flowing through an air seeder cart toward one or more soil furrows includes a housing for housing the agricultural additive; a rotational meter connected to the base of the housing to control a delivery rate of the agricultural additive exiting the housing; a motor connected to the meter for rotating the meter, wherein the motor can be controlled in correspondence with a movement speed of the air seeder cart; and a delivery tip extending beneath the meter for directing the agricultural additive into the stream of air, wherein the delivery tip is configured for extending into the stream of air to reduce the suction of agricultural additive out of the meter and into the stream of air.

Optionally, the delivery tip comprises a funnel.

Optionally, the delivery tip extends into the stream of air from the upstream side of the meter.

According to an aspect, an air seeder cart includes at least one air flow line; a fan for generating air flow in the at least one air flow line; a dispenser for supplying seed to the at least one air flow line; and a dispenser system for supplying agricultural additive to the at least one air flow line, wherein the system is configured for supplying the agricultural additive at a rate of 5 kilograms or less of agricultural additive per hectare of land.

Optionally, the air seeder cart further comprises a second dispenser for supplying fertilizer to the at least one air flow line.

Optionally, the air seeder cart further comprises a user interface displaying the volume of agricultural additive remaining within the dispenser.

Optionally, the dispenser system is located upstream of the fan.

Optionally, the dispenser system is located downstream of the fan.

Optionally, the dispenser system comprises a housing for containing the agricultural additive. Optionally, the dispenser system comprises a rotational meter connected to the base of the housing to control a delivery rate of the agricultural additive exiting the housing. Optionally, the dispenser system comprises a motor connected to the meter for rotating the meter, wherein the motor can be controlled in correspondence with a movement speed of the air seeder cart. Optionally, the dispenser system comprises a delivery tip extending beneath the meter for directing the agricultural additive into the air flow line, wherein the delivery tip is configured for extending into at least one air flow line to reduce the suction of agricultural additive out of the meter and into the at least one air flow line.

According to an aspect, a method of delivering agricultural products to a stream of air flowing through an air seeder cart toward one or more soil furrows includes dispensing seed stored in a first dispenser into the stream of air for delivery to the one or more soil furrows; and dispensing agricultural additive stored in a second dispenser into the stream of air at a rate of 5 kilograms or less of agricultural additive per hectare of land.

Optionally, the method further comprises storing a container in a cold storage unit before installing onto the second dispenser.

Optionally, the method further comprises breaking a seal on the container when the container is installed onto the second dispenser.

Optionally, the method further comprises mounting and sealing the container after installing onto the second dispenser.

Optionally, the method further comprises receiving, at a controller, a signal corresponding to the movement speed of the air seeder cart and controlling the rate at which agricultural additive is dispensed based on the signal.

In any of the above examples, the rotational meter may include a vibrator for preventing additive from sticking to the rotational meter.

In any of the above examples, the rotational meter may include a brush system for preventing additive from sticking to the rotational meter.

In any of the above examples, the rotational meter may include a fluted roller.

In any of the above examples, the container may be configured for housing a cooling block.

In any of the above examples, the air flow line may include a Venturi system for creating a pressure differential between the air flow line and the dispenser system at a location of the air flow line where the agricultural additive is delivered to the air flow line.

According to an aspects, an air seeder cart includes at least one air flow line; a fan for generating air flow in the at least one air flow line; a dispenser for supplying seed to the at least one air flow line; and a dispenser system for supplying agricultural additive to the at least one air flow line, wherein the dispenser system is located upstream of the fan.

The dispenser system may include a housing for containing the agricultural additive.

The dispenser system may include a rotational meter connected to the base of the housing to control a delivery rate of the agricultural additive exiting the housing.

The dispenser system may include a motor connected to the meter for rotating the meter, wherein the motor can be controlled in correspondence with a movement speed of the air seeder cart.

Optionally, the rotational meter includes an auger.

The dispenser system may include a secondary fan that directs an air flow into an inlet of the fan of the air seeder cart, wherein the dispenser system directs the agricultural additive into the air flow into the inlet of the fan of the air seeder cart.

It will be appreciated that any of the variations, aspects, features and options described in view of the systems apply equally to the methods and vice versa. It will also be clear that any one or more of the above variations, aspects, features and options can be combined.

### BRIEF DESCRIPTION OF THE FIGURES

The invention will now be described, by way of example only, with reference to the accompanying drawings, in which:

FIG. 1 depicts an exemplary air seeder cart comprising a fan, an air flow line, a dispenser for seed, an optional dispenser for fertilizer, and a dispenser system for agricultural additive, in accordance with some aspects;

FIG. 2 depicts an exemplary agricultural additive dispenser system comprising a housing, a rotational meter, a motor, and a delivery tip, in accordance with some aspects;

FIG. 3A depicts several exemplary installation locations of an agricultural additive dispenser system on an air seeder cart, in accordance with some aspects;

FIG. 3B depicts one exemplary installation location of an agricultural additive dispenser system on an air seeder cart in detail from a side view, in accordance with some aspects;

FIG. 3C depicts one exemplary installation location of an agricultural additive dispenser system on an air seeder cart in detail from an axial view, in accordance with some aspects;

FIG. 4 depicts an exemplary sealed container, housing, and rotational meter wherein the housing is configured to break the seal of the container and mount it to the housing, in accordance with some aspects;

FIG. 5 depicts a flow chart representing an exemplary method of operating an air seeder cart including an agricultural additive dispenser system, in accordance with some aspects;

FIG. 6 depicts an exemplary user interface for display metrics including the rate at which agricultural additive is dispensed and the volume of additive remaining within the hopper, in accordance with some aspects;

FIG. 7 depicts an exemplary vibrator and brush system located proximate to a rotational meter, in accordance with some aspects;

FIG. 8 depicts an exemplary computer, in accordance with some aspects;

FIG. 9 illustrates an example configuration of a delivery system that utilizes the Venturi effect to deliver agricultural additive to an air flow line;

FIG. 10 illustrates an exemplary configuration creating a pressure differential that can help ensure that the agricultural product is drawn into the air flow line and not forced back through a delivery pathway;

FIG. 11 illustrates an exemplary configuration in which the agricultural additive is directed into a separate air flow line that feeds into a main air flow line, with two Venturi systems being utilized to draw the agricultural additive into the respective lines;

FIG. 12 illustrates an example of sealing an upstream side of a meter from a downstream side of the meter;

FIGS. 13A-C and 14A-B illustrate various exemplary configurations for delivering agricultural additive upstream of a fan of an air seeder cart; and

FIG. 15 illustrates an optional manner of mounting a dispenser system to an air seeder cart.

### DETAILED DESCRIPTION

Reference will now be made in detail to implementations and aspects of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Disclosed herein are examples of systems and methods for the delivery of low-volume agricultural additives directly to the air stream of an air seeder cart and onto one or more soil furrows, thereby improving the uniformity of additive application relative to conventional techniques. The systems and methods involve the use of a dispenser system including a housing and a rotational meter to control the dispensation of additives into the air stream.

According to some aspects, additive may be directly added to the housing of the system and a lid placed over the top. A sensor may be included to detect the amount of additive within the housing and thus the remaining volume of additive. The sensor could be a sensor that detects the level of the additive (such as a distance sensor that measures the distance to the top of the additive in the housing or a weight sensor that measures the weight of the additive in the housing). Information about the remaining volume of additive including one or more metrics such as remaining volume, consumed volume, remaining percentage, and consumed percentage, may be displayed on a user interface placed within the vicinity of the air seeder cart operator.

To enable the delivery of low-volume additives in a controlled manner, the rotational meter is connected to a motor controlled by a controller using as an input the velocity of the air seeder cart traveling over the one or more soil furrows, to ensure that 5 kilograms or less of agricultural additive is dispensed per hectare of land. This input may optionally take the form of a sensor measuring the wheel speed of the air seeder cart. The rate at which agricultural additive is being added to the one or more soil furrows may be displayed on the user interface, in addition to other metrics which may serve as inputs for the calculation of agricultural additive dispensation rate such as velocity of the air seeder cart moving over the ground, spacing between one or more soil furrows, the width of the planting machine, the rate at which seed is being added to the one or more soil furrows, and the rate in hectares per hour at which soil furrows are being treated.

To enable the use of additive in the form of powder and/or granules, the material properties and/or surface finish of the housing, rotational meter, and/or other mounting components may be selected to minimize the accumulation of static charges. According to some aspects, the housing, rotational meter, and/or other mounting components may be connected to a ground, such as the chassis of the air seeder cart, via a conductive electrical path such as a wire or braided strap. Additionally, to reduce the suction of additive out of the rotational meter and into the stream of air, the dispenser system may optionally include a delivery tip extending below the rotational meter and reducing exposure of the additive exiting the meter to the low-pressure region created by the stream of air.

To reduce the likelihood of thermal spoilage of temperature-sensitive agricultural additives, such as live bacterial, fungal, and/or microbial inoculums, instead of directly adding the additives to the housing, a separate sealed and optionally insulated container may be stored in an active or passive cold storage unit before being installed onto the housing. The optional insulation may include low thermal conductivity materials to reduce thermal conduction and/or the addition of a low emissivity coating to reduce thermal radiation. The seal of the container may optionally be broken by a seal-breaking mechanism located on the housing, such that when the seal is broken, additive is able to enter the rotational meter. The seal may alternatively be removed manually by an operator of the air seeder cart. To mount and seal the container to the housing, an optional container-locking mechanism included below the housing may be actuated by an air seeder cart user.

To enable the dispensation of two or more distinct additives, the housing may be split into two compartments and/or multiple dispenser systems may be attached to the air seeder cart. The systems and methods may further include retrofitting the dispenser system onto a pre-existing air seeder cart, enabling a standardized means of delivering agricultural additives. This retrofitting may optionally involve the drilling of a hole in the air flow line of a pre-existing air seeder cart, the use of a bracket attached to the rotational meter, and the use a gasket and/or sealing grommet to fasten and seal the dispenser system to the air flow line.

In the following description, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some aspects also relates to devices or systems for performing the operations herein. The devices or systems may be specially constructed for the required purposes, may comprise a general purpose computer selectively activated or reconfigured by a computer program stored in the computer, or may include any combination thereof. Computer instructions for performing the operations herein can be stored in any combination of non-transitory, computer readable storage medium, such as, but not limited to, any type of disk, including floppy disks, USB flash drives, external hard drives, optical disks, CD-ROMs, magnetic-optical disks, read-only memories (ROMs), random access memories (RAMs), EPROMs, EEPROMs, magnetic or optical cards, or any type of media suitable for storing electronic instructions, and each coupled to a computer system bus. One or more instructions for performing the operations herein may be implemented in or executed by one or more Application Specific Integrated Circuits (ASICs), Field Programmable Gate Arrays (FPGAs), Digital Signal Processing units (DSPs), Graphics Processing Units (GPUs), or Central Processing Units (CPUs). Furthermore, the computers referred to herein may include a single processor or may be architectures employing multiple processor designs for increased computing capability.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The required structure for a variety of these systems will appear from the description below. In addition, the present invention is not described with reference to any particular programming language. It will be appreciated that a variety of programming languages may be used to implement the teachings of the present invention as described herein.

Although the following examples often refer to the delivery of an agricultural additive simultaneously with a seed and a fertilizer during planting, it is within the scope of the invention to use the systems and methods disclosed to deliver a mixture of one or more seed types, one or more fertilizer types, and one or more agricultural additive types. Further, it is within the scope of the invention to dispense only seed and agricultural additive and to not dispense fertilizer.

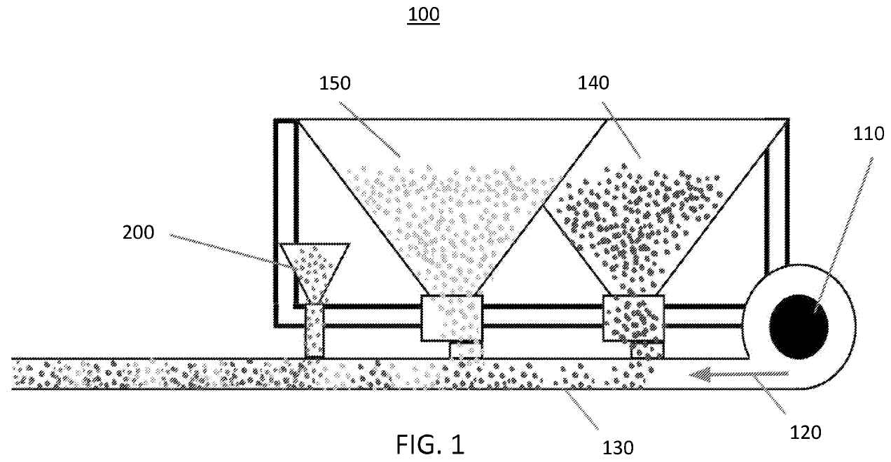

FIG. 1 depicts an example of an air seeder cart 100 configured for the distribution of low-volume agricultural additive along with seed (and, optionally, fertilizer) to soil furrows. The air seeder cart 100 may include a fan 110 for creating a stream of air 120 flowing through an air flow line 130 toward one or more soil furrows. Air flow line 130 may be the main, secondary, or tertiary air flow line. One or more dispensers may be attached to this air flow line 130, including a dispenser 140 for supplying seed and an agricultural additive dispenser system 200 for supplying small amounts of agricultural additive. A dispenser 150 for supplying fertilizer may also be attached to the air flow line 130. The agricultural additive dispenser system 200 is configured to deliver small amounts of agricultural additive to the same air flow line as the seed (and, optionally, fertilizer), which enables efficient mixing of the additive with the seed and/or fertilizer, as well as uniform deposition into the one or more soil furrows. The inclusion of a dispenser system 200 for supplying agricultural additive enables the agricultural additive to mix with the seed and/or fertilizer, and/or to coat the seed and/or fertilizer particles. This enables a more uniform combination of the additive with the seed and/or fertilizer, particularly when compared to conventional techniques that involve dispensing additive above seed and/or fertilizer as it moves through an auger tube. This benefit is especially pronounced when seeds are used that have been pre-coated with high concentrations biocides such as fungicides and/or pesticides that would harm the agricultural additive upon direct exposure, or that have been left uncoated but contain high concentrations of epiphytic fungi or other microbes that may compete with the additive. In both instances, the use of a dispenser system to transmit additive alongside the seed instead of primarily coated on it, allows the additive to reach the one or more soil furrows in close proximity to the seed and/or fertilizer while minimizing direct exposure to biocides on coated seeds and/or to competitive epiphytic fungi on uncoated seeds, thereby increasing the efficacy of the agricultural additive. In some examples, the air flow line 130 may include a dimpled pipe to force the air flow carrying the seed and agricultural additive to the center of the pipe thereby decreasing variation in the rate at which the biological product is applied.

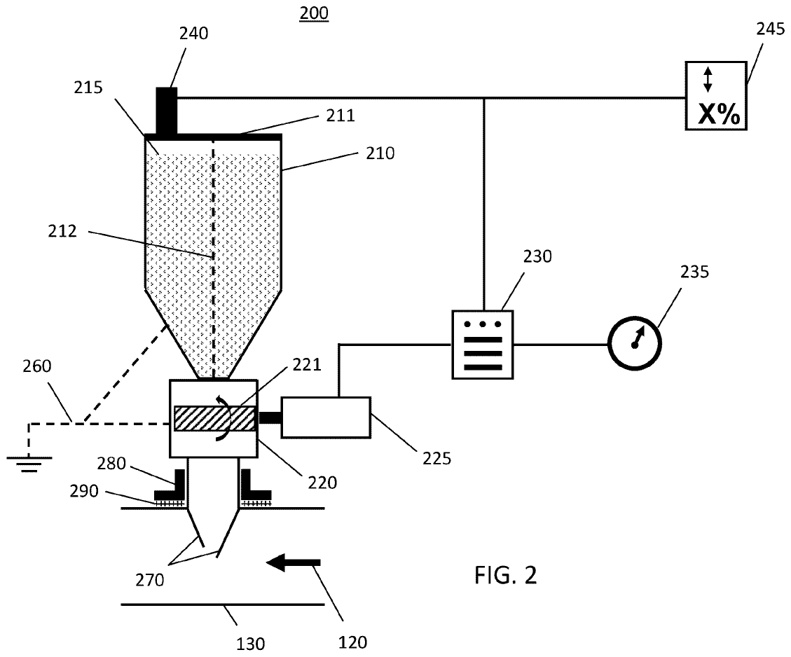

FIG. 2 depicts an agricultural additive dispenser system 200, which may be configured to attach to the air flow line 130 of an air seeder cart 100. The agricultural additive dispenser system 200 is smaller than more common agricultural dispensers such as seed and fertilizer dispensers 140 and 150 as shown in FIG. 1. The dispenser system 200 may include a housing 210 (also referred to herein as a hopper) for containing one or more agricultural additives 215 and may have a capacity within the range of 0.1-50 liters. Low-volume additives that may be dispensed by dispenser system 200 may include biological products such as microbial inoculums containing colony forming units or propagules of fungi, bacteria, microalgae, cyanobacteria and may include one or more of seaweed extracts, plant extracts, biochar, compost, one or more root stimulants, rhizospere modifiers, Rhizobium inoculums, nitrogen fixers, phosphate solubilisers, Trichoderma, Serendipita, Piriformospora, arbuscular mycorrhiza fungi (AMF), and/or inorganic soil additives including macronutrients and/or micronutrients. According to some aspects, low-volume additives dispensed may include a combination of soil carbon inoculums and peat-based Rhizobium inoculums. Housing 210 may include a lid 211, which may be removed to allow the addition of additive 215 and replaced once the addition of additive is complete. Housing 210 may also include a divider 212 to allow the simultaneous dispensation of two or more additives.

The housing 210 may be installed onto a rotational meter 220 to control the rate of dispensation of the additive 215 into the stream of air 120. The rotational meter 220 may include a segmented rotational device 221 which may take the form of a wheel, an auger, a screw, a worm gear or a fluted worm gear, or a fluted roller and may be composed of a plastic and/or metal material such as bronze. The depth, spacing, and other attributes of the grooves included on, for example, a fluted worm gear or fluted roller, may optionally be selected to optimize the passage of agricultural additive 215, which may be composed of a mixture of one or more low-volume additives, through the rotational meter 220 and ensure accurate dispensation into the stream of air 120. This optimization may take into account, for example, the type of additive or additives being employed and size of individual particles of the additive or additives. According to some aspects, grooves may be 0.3 to 1.7 mm in depth, or more preferably 0.5 to 0.9 mm in depth, and spaced 0.7 to 3.5 mm apart, or more preferably spaced 1.2 to 2.1 mm apart. To prevent the sticking of additive within individual grooves of for example a fluted roller, in addition to adjusting the depth and/or spacing of grooves, the fluted pattern may optionally be selected to include grooves in the shape of a spiral, a chevron or “zig-zag,” and/or a series of parabolic curves.

The rotational meter may be driven by a variable-rate motor 225, optionally connected to the rotational device 221 via an associated transmission system optionally involving one or more gears and/or chain drives, that may be controlled by a controller 230. The controller may use as an input a signal from a sensor 235 which measures a signal corresponding to the velocity of the air seeder cart, for example the wheel speed of the cart. Using this method, the controller 230 ensures that the rotational meter 220 is dispensing agricultural additive 215 at a rate corresponding to the velocity at which the air seeder cart is moving over the one or more soil furrows. This rate, and the volume of additive dispensed, may be lower than that of the seed and/or fertilizer, corresponding to 5 kilograms or less of agricultural additive per hectare of land. This rate can be set by the user of the air seeder cart by adjusting a parameter within controller 230 after, for example, testing the effect of various rates on the composition of agricultural products within treated soil furrows, and may be displayed on a user interface 245 placed within the vicinity of the air seeder cart operator. In addition to displaying the rate at which agricultural additive is dispensed, the user interface may optionally display other metrics which may serve as inputs for the calculation of agricultural additive dispensation rate such as velocity of the air seeder cart moving over the ground, spacing between one or more soil furrows, the width of the planting machine, the rate at which seed is being added to the one or more soil furrows, and the rate in hectares per hour at which soil furrows are being treated. The motor and controller may optionally be stored in a casing to provide protection from electromagnetic interference, environmental contamination such as the intrusion of dust or agricultural products, and vibration damage.

The system 200 may optionally include a sensor 240 detecting the height of the additive 215 within the housing 210 thereby measuring the volume of additive remaining. This remaining volume may optionally be displayed on the user interface 245. The user interface may display information about the additive remaining using one or more of the following metrics: remaining volume, consumed volume, remaining percentage, and consumed percentage. This information may optionally update at an increment of 25%, for example alerting the user when the volume of additive 215 is 100%, 75%, 50%, 25%, and 0% of the maximum capacity of housing 210.

The additive 215 may take the form of powder, granules or pellets, a combination of both powder and granules or pellets, grits, or chips. In embodiments combining powder and granules, the ratio of powder to granules may be selected to minimize risks to the undisrupted dispensation of additive out of the housing, through the rotational meter, and into the stream of air 120. These risks could take the form, for example, of a blockage of additive within the rotational meter or of an accumulation of static charges on the interior surfaces of housing 210, rotational meter 220 and/or other mounting components. To minimize the accumulation of static charges on the housing, rotational meter, and/or other mounting components, the system 200 may optionally include an electrically conductive path 260, such as a conductive wire or strap, connecting housing 210, rotational meter 220 and/or other mounting components to a ground point, such as the chassis of the air seeder cart 100. The system may optionally include a housing 210, rotational meter 220 and/or other mounting components whose properties are selected to minimize the accumulation of static charges. Such property selection may involve the selection of one or more surface finishes that minimize the accumulation of static charges during interaction with the additive powder and/or granules. The property selection may also involve the selection of one or more materials with a high electrical conductivity.

Use of additive 215 in the form of powder and/or granules delivered into a stream of air 120 introduces the risk of the stream affecting the flow of powder and/or granules through the rotational meter 220. This is especially true if the stream of air 120 is flowing at a high velocity, creating a low pressure zone below the rotational meter and increasing the risk of suction of additive 215 out of the rotational meter 220 and into the stream of air. To address this risk, system 200 may optionally include a delivery tip 270 extending into the stream of air 120, thereby reducing exposure of the additive 215 flowing out of the rotational meter to a low pressure region in the stream of air. This delivery tip may include a funnel, and/or may extend into the stream of air further on the upstream side relative to the downstream side.

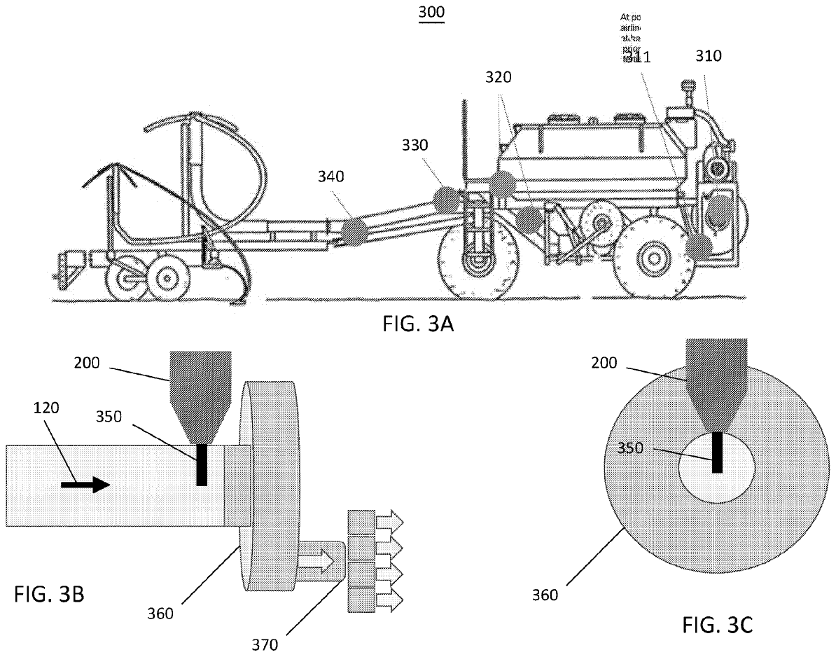

FIG. 3A depicts several possible installation locations for the agricultural additive dispenser system 200 on an air seeder cart 100. Each location is on the primary air flow line 130 and would enable mixing and/or coating of the additive with seed and/or fertilizer. The system could optionally be placed on the upstream or downstream side of the air seeder cart fan near locations 310 or 311 respectively. The system could instead optionally be placed downstream of or in the vicinity of the seed and/or fertilizer dispensers near 320. For example, the system 200 could be placed upstream of both the seed and fertilizer dispensers, between the two dispensers, or downstream of the two dispensers. The system could optionally be placed further downstream near 330, on the outside of the central frame of the air seeder cart. The system 200 could also optionally be placed further downstream on the primary air flow line near 340, upstream of the division of the primary air flow line into secondary air flow lines. Additionally, the system could be located downstream of this division, on the secondary or tertiary air flow lines. For the delivery of two or more additives, two or more dispenser systems 200 could be installed onto the air seeder cart, at one or more of the above-described installation locations.

FIG. 3B depicts one potential installation location of agricultural additive dispenser system 200: the upstream side of the fan 360, depicted as location 310 in FIG. 3A. To ensure complete mixing and uniform application of additive 215 into one or more soil furrows, a delivery tube 350 may optionally be used to deliver additive to the center of the air flow line 130, in this case upstream of fan 360. According to some aspects, after passing through the fan, the additive would travel further down air flow line 130 before reaching air flow distribution box 370, serving to divide the primary air flow line into secondary air flow lines as previously mentioned. FIG. 3C depicts the same installation location as FIG. 3B only now shown from a point of view aligned with the axis of the air flow line 130. As shown in FIG. 3C, delivery tube 350 stretches to the center of the air-flow line cross-section, thereby insuring uniform dispensation of agricultural additive 215 into the air flow line 130 and fan 360.

The agricultural additive dispenser system 200 may be designed to be retrofit onto pre-existing air seeder carts in addition to inclusion as part of newly manufactured air seeder carts. As shown in FIG. 2, this retrofitting may involve the drilling of a hole in the air flow line 130 of a pre-existing air seeder cart, and the fastening of bracket 280 to the rotational meter 220 and the optional delivery tip 270 and to the air flow line so as to mount the dispenser system onto the air flow line. Gasket 290 may be placed between the bracket and the air flow line to minimize the leakage of air and/or agricultural additive passing out of the rotational meter and into the air flow line. To accomplish this, gasket 290 may be composed of a polymer or other soft material. Mechanical components including the housing 210, the rotational meter 220 and associated controller 230, and the mounting which may include bracket 280 and gasket 290, are designed to withstand the mechanical vibration and environmental contamination, such as the presence of dust, that are common during agricultural operations. The ability of the system to be installed on pre-existing air seeder carts, combined with the above-described installation location flexibility including the multiple possible locations shown in FIG. 3A, ensures a standardized agricultural additive delivery system can be included regardless of the air seeder cart configuration that a given farming operation employs.

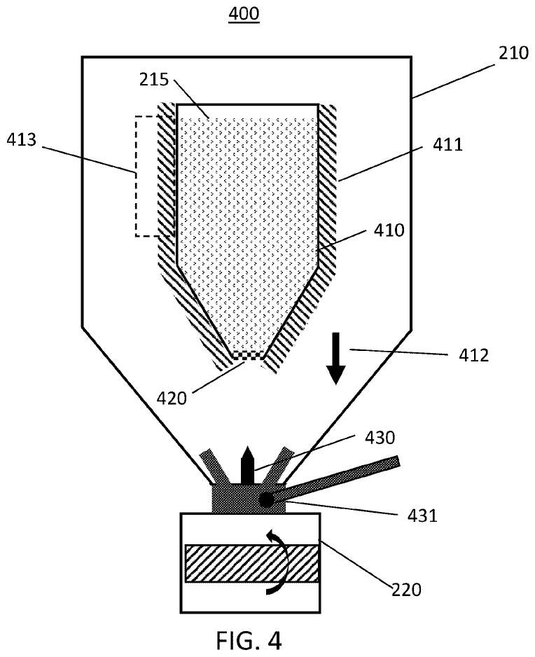

FIG. 4 depicts a seal 420 placed on container 410, and a seal-breaking mechanism 430 within housing 210. A seal placed over the container minimizes contamination of the agricultural additive 215 with materials that could reduce the effectivity of the additive or disrupt crop growth were it to reach the one or more soil furrows. The presence of seal 420 also reduces the likelihood that any tampering occurred between the production of the low-volume agricultural additive and the installation of the container 410 onto the dispenser system. The seal 420 may include a metal, plastic, and/or paper layer or foil adhered to the top of the container, capable of breaking upon impact of the seal-breaking mechanism.

The seal-breaking mechanism 430 may be attached to the bottom of the housing 210 and be configured to break seal 420 when container 410 is attached. The seal, container, and seal-breaking mechanism may be configured such that only a container of an expected design may be attached to, and the seal of the container broken by, the housing and seal-breaking mechanism respectively. Such matching of the design of interfacing components, in this case ensuring that only an approved/expected container can be installed, is often referred to as “poka-yoke.” The seal-breaking mechanism 430 may take the form of a central spike which may optionally have a hollow center through which the additive may flow before passing through the rotational meter 220.

To enable the mounting of container 410 onto housing 210, a container-locking mechanism 431 may be used. The container locking mechanism may also include a soft material on the top surface to seal the bottom surface of the container 410 and ensure a minimum of material escapes container 410 and enters hopper 210 after seal 420 has been broken. Container-locking mechanism 431 may also include a lever handle to enable the mounting and sealing functions of the mechanism. This lever handle may be actuated by a user after installing container 410 onto seal-breaking mechanism 430. After mounting of container 410 using both seal-breaking mechanism 430 and container-locking mechanism 431, agricultural additive 215 may pass out of container 410, through container-locking mechanism 431, through rotational meter 220 and into the air flow line 130.

The container 410 may optionally include insulation 411 which may thermally insulate the container 410. As previously mentioned, the use of low-volume agricultural additives including live bacterial, fungal, and/or microbial inoculums with temperature sensitivity poses a challenge given that additive needs to be mixed with and/or coated on seed and/or fertilizer to ensure uniform delivery onto one or more soil furrows. However, applying the additive even several hours before delivery to the one or more soil furrows can risk thermal spoilage or other degradation of the additive. To reduce the transfer of heat into container 410, and associated thermal spoilage concerns, the insulation 411 may include a material with low thermal conductivity such as a ceramic or plastic to reduce thermal conduction. For the same reason the insulation 411 may also include a low emissivity coating to reduce thermal radiation. Insulation 411 may be included as part of the wall of container 410 or as a separate insulated portion into which container 410 is placed. To further control the temperature of the additive, the container 410 and/or housing 210 may optionally be configured for accommodating one or more cooling blocks 413 that may be removed from a refrigerated container and inserted into the container 410 and/or housing, thereby maintaining a low temperature of additive 215 within container 410 for a longer period. The cooling block(s) may be positioned outside of the insulation 411 or within the insulation 411. Should the cooling blocks warm to an excessive degree, the cooling blocks may optionally be substituted for cooling blocks at lower temperature (for example after being removed from a cooler within the air seeder cart) providing a means of on-the-go thermal maintenance of, for example, an agricultural additive that is especially sensitive to changes in temperature.

Prior to installation onto the agricultural additive dispenser system 200, container 410, optionally including insulation 411, may be stored in an active or passive cold storage unit, such as a refrigerator or insulated cooler. An air seeder cart user may then remove the container from the cold storage unit, remove an optional cap from the container, open the lid 211 of housing 210, insert the container onto the seal-breaking mechanism 430 until the seal is broken and the container is seated, actuate container-locking mechanism 431, and replace the lid of the housing. Thus, provision for storage of the container within a cold storage unit and for thermal insulation of the container, optionally including cooling blocks for extended thermal maintenance, enables an air seeder cart operator to minimize the risk of thermal spoilage of the agricultural additive.

Container 410 and housing 210 may optionally be configured such that the container includes seal 420 but the housing does not include seal-breaking mechanism 430, such that an operator breaks or removes the seal manually before installation into the housing. The housing and container in such a configuration may include the poka-yoke design method described above to ensure only approved/expected containers can be attached to the housing 210, and container-locking mechanism 431 to ensure reliable mounting and sealing of the container.

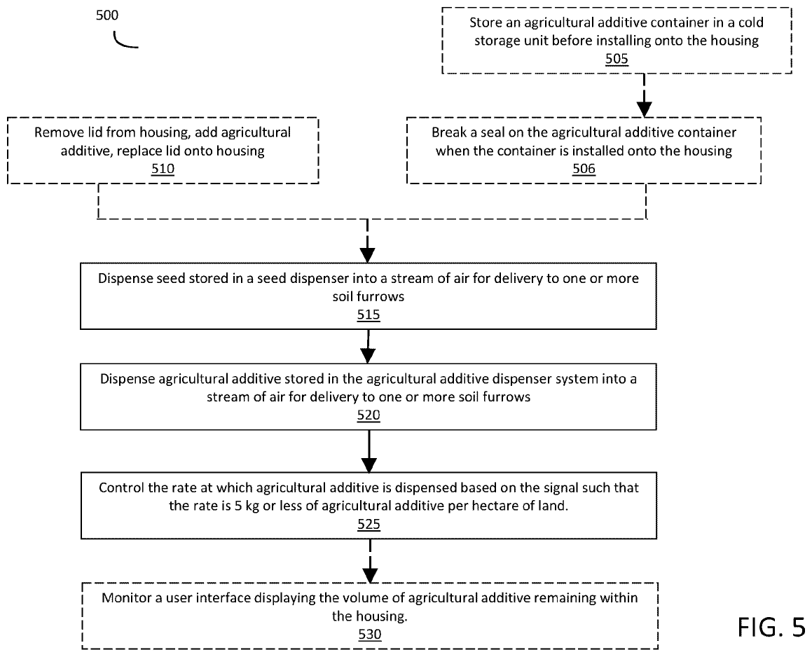

FIG. 5 depicts a flow chart representing an exemplary method of operating an air seeder cart 100 with an agricultural additive dispenser system, such as dispenser system 200 of FIG. 2. At optional block 505, a container 410 containing agricultural additive 215 and optionally surrounded by insulation 411 to provide thermal insulation may be stored at low temperatures, such as those found within an active or passive cold storage unit, in order to preserve the additive if it is susceptible to elevated temperatures (e.g., the additive may include live bacterial, fungal, and/or microbial inoculums). Once removed from the cold storage unit, container 410 may be placed within housing 210 located above rotational meter 220 which may allow controlled dispensation of the additive into the stream of air 120.

The container 410 may include a seal 420 which, at optional block 506, may be broken during installation of the container into housing 210. As discussed above and shown in FIG. 4, this breaking of the seal may involve seal-breaking mechanism 430 and/or it may involve the removal of seal 420 by an operator before installation of the container onto the rotational meter. The mounting and sealing of container 410 may involve container-locking mechanism 431 as shown in FIG. 4.

In embodiments in which container 410 is not used (e.g. in instances in which no sealing or low temperature storage is required), optional blocks 505 and 506 can be skipped. Instead, at optional block 510 and as shown in FIG. 2, lid 211 of housing 210 may be removed, agricultural additive 215 added directly to the housing, and the lid replaced onto the housing.

Following the optional process steps detailed in blocks 505, 506, and 510, at block 515, seed is dispensed using a seed dispenser 140 into the stream of air 120 of the air seeder cart 100 flowing toward one or more soil furrows. The rate at which seed is dispensed may be controlled such that the rate varies with the velocity at which the air seeder cart is traveling over the one or more soil furrows.

In what may occur in a simultaneous manner with the dispensation of seed, at block 520, the agricultural additive dispenser system 200 is used to dispense low-volume agricultural additive 215 into the stream of air 120 of the air seeder cart 100. In the process of dispensing the additive, at block 525, the rotational meter 220 of the system may be used to control the rate of dispensation via a controller 230 which takes as an input the wheel velocity of the air seeder cart as measured by sensor 235. The controller may control the rotational meter to ensure that no more than 5 kilograms of agricultural additive per hectare of land is added to the one or more soil furrows. Preferably, the rate of delivery is no more than 3 kilograms of agricultural additive per hectare of land. More preferably, the rate is no more than 1 kilograms of agricultural additive per hectare of land. Most preferably, the rate of delivery is 30-100 grams of agricultural additive per hectare.

To monitor the amount of agricultural additive 215 remaining, a sensor 240 may optionally be included on the lid 211 of housing 210 to monitor the level, and thus the remaining volume, of the additive within the housing. At optional block 530 this information, which may include remaining volume, consumed volume, remaining percentage, and/or consumed percentage of agricultural additive, may then be displayed on a user interface 245 placed within the vicinity of an operator of the air seeder cart.

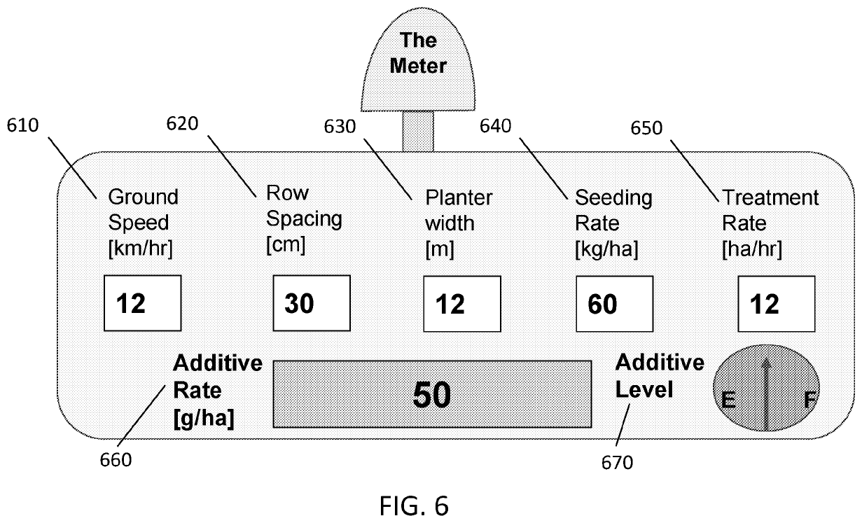

FIG. 6 depicts one optional embodiment of user interface 245 placed within the vicinity of the air seeder cart operator, for example within the cab that the operator is operating the air seeder cart from. Such a user interface may contain metrics such as the rate at which agricultural additive 215 is being added to the one or more soil furrows (displayed at 660) and the volume of agricultural additive 215 remaining in hopper 210 (displayed at 670). These metrics may be accompanied by others which may serve as inputs for the calculation of agricultural additive dispensation rate such as velocity of the air seeder cart moving over the ground (displayed at 610), spacing between one or more soil furrows (displayed at 620), the width of the planting machine (displayed at 630), the rate at which seed is being added to the one or more soil furrows (displayed at 640), and the rate in hectares per hour at which soil furrows are being treated (displayed at 650). With respect to the previously described metrics, excluding the volume of remaining additive, the values displayed may be detected by one or more sensors included on the air seeder cart and/or planter and directly displayed, directly entered by the operator of the air seeder cart based on observations or knowledge, calculated based on the values detected by said sensors and/or directly entered by the operator, or some combination thereof.

The previously described metrics may optionally be displayed on a pre-existing in-cab fertilizer and seed control unit such as a Greenstar (manufactured by John Deere) or a Trimble (manufactured by Case IH) device, including the previously described functionality. The previously described metrics may optionally be displayed on a separate user interface similar to the one shown in FIG. 6, which may be titled “The Mushy Meter.”

According to some aspects, rotational meter 220 may include a fast-empty chute consisting of an entry valve and tube that enables additive 215 to bypass the metering portion of the meter, e.g. the portion with a wheel, an auger, a screw, a worm gear or a fluted worm gear, or other segmented rotational device, flowing directly from the hopper 210 or container 410 to the air flow line 130, optionally passing through delivery tip 270. Such a fast-empty chute would give the user of the air seeder cart the ability to rapidly dose a portion of one or more soil furrows with a relatively high dosage of agricultural additive or to ensure that all additive in a hopper or container has been expended.

According to some aspects, in place of rotational meter 220, the agricultural additive dispenser system 200 may include a Venturi injection meter system to control the flow of agricultural additive exiting the hopper 210 or container 410 and entering the air flow line 130. Such a meter system may include a secondary air flow line, splitting off the main air flow line 130 upstream of the system 200 and rejoining the main air flow line downstream of the system 200. Such a secondary air flow line may include an upstream control valve, upstream of system 200, and a downstream control valve, downstream of system 200, to control the pressure within the secondary air flow line. Between these two valves and below hopper 210 may be placed a Venturi injection meter which may include a section of reduced cross-sectional area relative to the cross-sectional area of the portion of the secondary air flow line immediately downstream of this section. Such a reduced cross-sectional area section below the hopper has the function of creating a local reduction in air pressure, thereby enabling the suction of agricultural additive 215 out of hopper 210 or container 410. Thus, by modulating the pressure with the upstream and/or downstream control valves, the flow rate of additive into the Venturi injection meter can be modulated. To ensure sufficient air flow out of the main air flow line 130 and into the secondary air flow line, a booster pump may be added upstream of the upstream control valve.

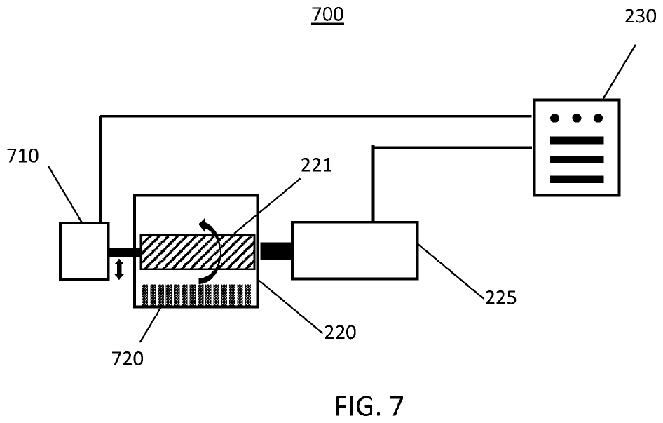

FIG. 7 depicts several optional embodiments proximate to or within rotational meter 220 to improve the passage of agricultural additive 215 through the rotational meter while minimizing sticking and/or clogging of the additive particularly at segmented rotational device 221, thereby ensuring the accurate dispensation of the additive into the stream of air 120 flowing through the air seeder cart toward one or more soil furrows. To the extent sticking and clogging are a function of the particulate size of the additive 215, for example retaining more additive when it contains a high proportion of powder, the parameters of the optional embodiments may optionally be optimized to minimize retention of the particular additive or additive combinations that will be used as discussed further below.

To minimize the degree to which additive 215 becomes lodged within the grooves or segments of rotational device 221, one or more variable-rate vibrators 710 may optionally be placed in contact with the rotational device and controlled by controller 230. One or more vibrators 710 may optionally be located, for example, coaxially with the rotational device 221 at the opposite side of motor 225, as depicted in FIG. 7. One or more vibrators 710 may optionally be located elsewhere, for example contacting the rotational device laterally, from above or below the rotational meter 220. Alternatively, a vibrator 710 may optionally be attached to the motor 225 and/or the transmission system associated with the motor, simultaneously vibrating the motor and/or transmission system and rotational device 221. To isolate vibration from the rest of the air seeder cart, to ensure pressure within the air seeder system is maintained, and/or to allow the rotational device 221 to move laterally and independently of the motor 225, the attachment between the rotational device and the motor and/or transmission system may optionally include a flexible coupling, and/or the attachment of the motor and/or transmission system to the rotational meter may optionally include a flexible seal. Similar to optimization of the design of rotational device 221 based on the type of agricultural additives and associated particulate sizes that will be used with the system, the vibration magnitude and frequency of vibrator 710 may optionally be optimized to minimize the amount of additive retained by the rotational device.

To further minimize the degree to which additive 215 becomes lodged within the grooves or segments of rotational device 221, a brush system 720 composed of one or more brushes may optionally be placed in proximity to and/or in contact with the rotational device, thereby increasing removal of trapped additive. Similar to optimization of the design of rotational device 221 and operational parameters of vibrator 710 based on the type of agricultural additives and associated particulate sizes that will be used with the system, aspects of the brush system 720 such as for example bristle thickness, length, and stiffness may optionally be selected to minimize the amount of additive retained by the rotational device.

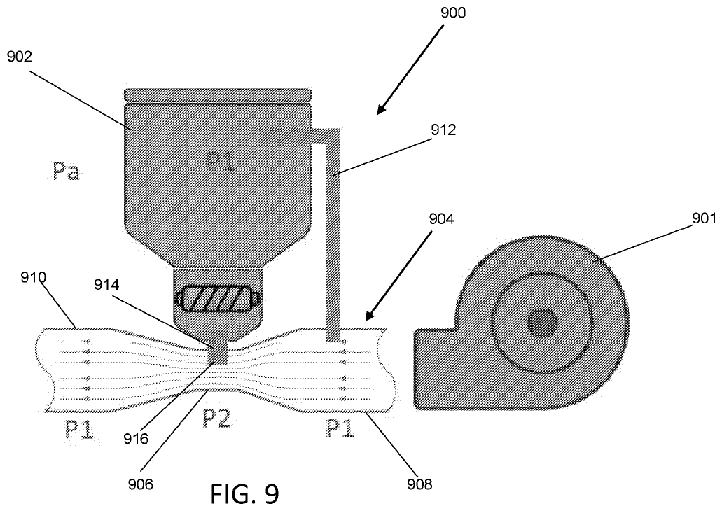

The delivery of agricultural additive into the stream of air flowing through the air seeder cart may be aided via a pressure differential between one or more portions of the dispenser system and the air flow line into which the agricultural additive is introduced. FIG. 9 illustrates an example configuration of a delivery system 900 that utilizes the Venturi effect to create a pressure, P1, inside the container 902 containing the agricultural additive that is higher than the pressure, P2, at the location where the agricultural additive is delivered to the air flow line 904. This “Venturi system” configuration can help ensure that agricultural additive is drawn into the air flow line 904 and not pushed back toward the container 902.

The air flow line 904, which is positioned downstream of the fan 901 includes a necking section 906 that has a diameter that is smaller than the diameter of an upstream section 908 and a downstream section 910. This reduction in air flow diameter ensures that the static air pressure, P2, in the necking section 906 is lower than the static air pressure, P1, in the upstream and downstream sections. A pressure tap line 912 can fluidly connect the upstream section 906 to the container 902 that contains the agricultural additive. The container 902 may be sealed against the ambient air pressure, Pa, sufficiently that the pressure, P1, in the upstream section 908 is substantially the pressure in the container 902 (or at least a pressure that is higher than P2) due to the fluid connection of the pressure tap line 912. A delivery conduit 914 may deliver the agricultural additive to the necking section 906 of the air flow line 904. Thus, the static pressure at the outlet 916 of the delivery conduit 914 (P2) is lower than the static pressure in the container 902 (P1), resulting in a pressure differential that encourages the agricultural additive to flow into the air flow line 904 and not back up the delivery conduit 914.

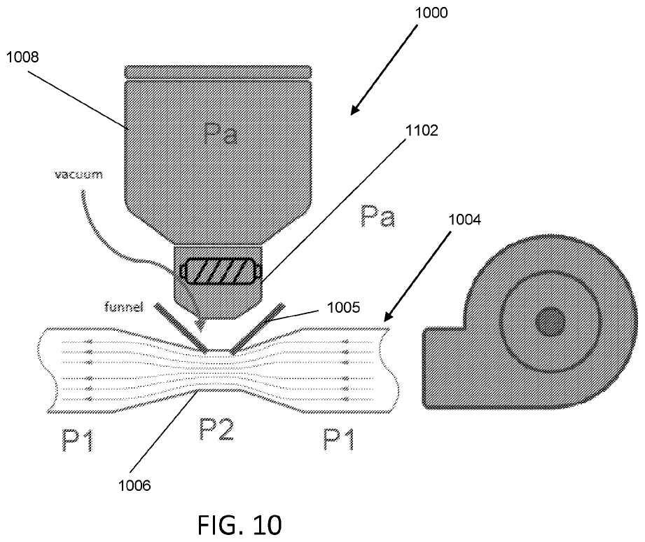

FIG. 10 illustrates an example of another way of creating a pressure differential that can help ensure that the agricultural additive is drawn into the air flow line and not forced back through the delivery pathway. In the example system 1000 of FIG. 10, the agricultural additive is directed from the meter 1002 into a delivery pathway 1005 (e.g. a funnel) that is open to ambient pressure, Pa. The delivery pathway 1005 leads into the air flow line 1004 at a necking section 1006, similar to the example of FIG. 9. The necking section 1006 is configured so that the static pressure in the necking section 1006, P2, is lower than the ambient air pressure, Pa. This pressure differential creates a vacuum in the delivery pathway 1005 that will tend to draw the agricultural additive into the air flow line 1004. In this example, the container 1008 containing the agricultural additive need not be sealed against the ambient air pressure, which can make its design simpler and more cost effective.

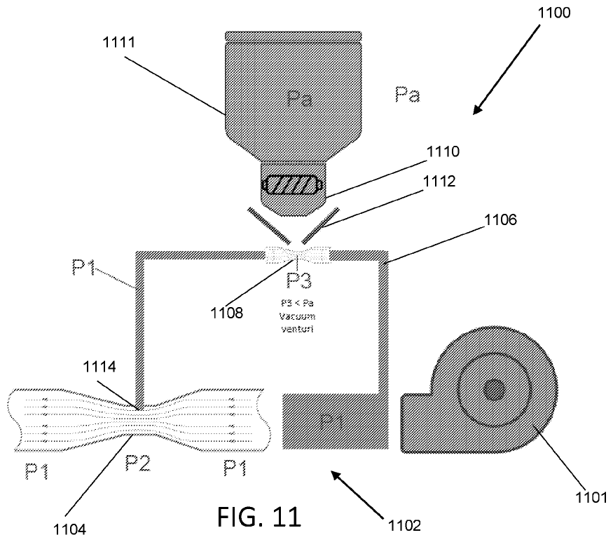

FIG. 11 illustrates a variation of the example of FIG. 10 in which the agricultural additive is directed into a separate air flow line that feeds into a main air flow line, with two Venturi systems being utilized to draw the agricultural additive into the respective lines. In the example system 1100, a main air flow line 1102 includes a necking section 1104. A secondary air flow line 1106 connects to the main air flow line 1102 upstream of the necking section 1104 and downstream of the fan 1101. The secondary air flow line 1106 reconnects to the main air flow line 1102 at the necking section 1104. The secondary air flow line 1106 includes a necking section 1108. The agricultural additive is directed from the meter 1110 of the dispenser 1111 into a delivery pathway 1112 that is open to ambient air pressure, Pa. The delivery pathway 1112 leads into the necking section 1108 of the secondary air flow line 1106. The necking section 1108 is configured so that the Venturi effect results in a pressure, P3, in the necking section 1108 that is lower than the ambient air pressure, Pa, resulting in a vacuum that draws the agricultural additive into the secondary air flow line 1106.

Air flow within the secondary air flow line 1106 carries the agricultural additive to the outlet 1114 of the secondary air flow line 1106 at the necking section 1104 of the main air flow line 1102. The pressure in the secondary air flow line 1106 is substantially the pressure, P1, in the main air flow line 1102 upstream and downstream of the necking section 1104. The necking section 1104 is configured so that the Venturi effect causes a pressure, P2, in the necking section 1104 that is lower than the pressure, P1, in the secondary air flow line 1106. This pressure differential draws the agricultural additive from the secondary air flow line 1106 into the main air flow line 1102. The utilization of the secondary air flow line 1106 may provide for flexible positioning of the dispenser 1111.

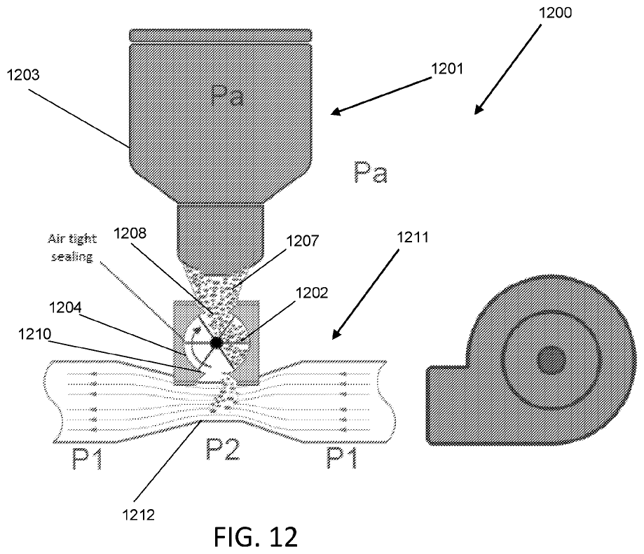

In any of the example systems above that utilize the Venturi effect to draw agricultural additive into the air flow line or any other variations, the meter of the dispenser may be configured to seal the upstream side of the meter from the downstream side of the meter to ensure that agricultural additive is not blown back into the dispenser. FIG. 12 illustrates an example of such a configuration. The exemplary system 1200 includes a dispenser 1201 that has a paddle wheel-like meter 1202 that may seal against a wall 1204 of the chamber in which it is positioned. Agricultural additive 1207 may be gravity fed into segments of the meter 1202 when the segments align with an inlet opening 1208 of the wall 1204. The agricultural additive 1207 may be carried in segments of the meter 1202 as the meter 1202 rotates until a respective segment is aligned with an outlet opening 1210 of the wall 1204, which communicates with the air flow line 1211. Due to the sealing of the meter 1202 against the wall 1204, a given segment of the meter 1202 that is aligned with the outlet opening 1210 is at the same pressure as the location of the air flow line 1206 with which the outlet opening 1210 communicates, and at the same time, a given segment of the meter 1202 that is aligned with the inlet opening 1208 is at the same pressure as the container 1203 (which may be ambient air pressure). In the illustrated example, the outlet opening 1210 communicates with a necking section 1212 of the air flow line 1211, which may be configured to utilize the Venturi effect to produce a lower static pressure, P1, relative to the upstream and downstream pressure, P2, but this pressure, P1, need not be lower than the ambient pressure, Pa, due to the seal of the meter 1202. In some variations, no necking section 1212 is used (for example, the air flow line 1211 may have a continuous diameter). System 1200 may provide flexibility in how the air flow line 1206 is configured and in how and where the dispenser 1201 is connected to the air flow line 1206.

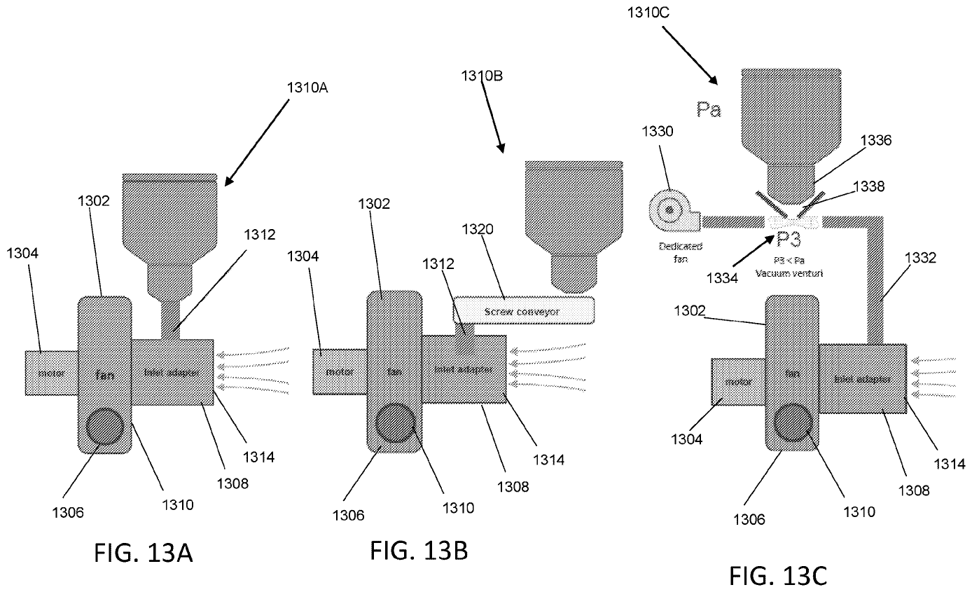

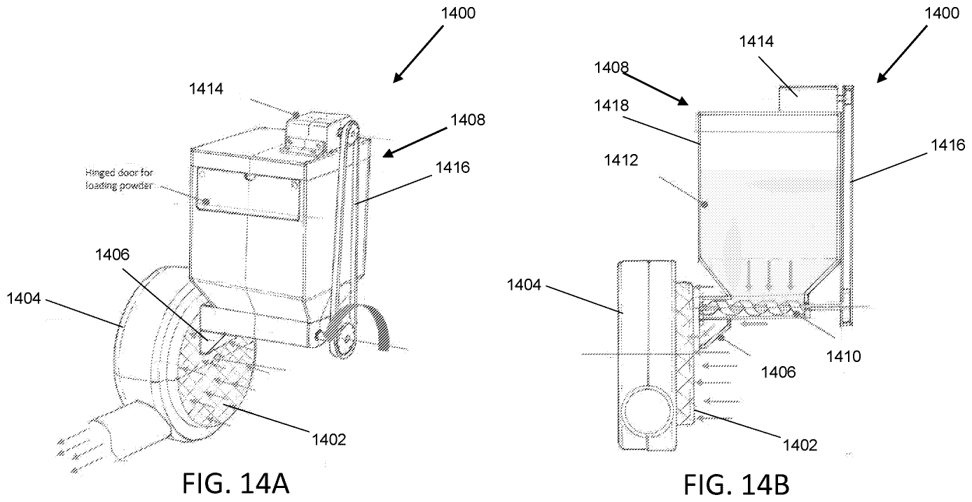

As noted above in the discussion of possible installation locations for the agricultural additive dispenser system on an air seeder cart, such as depicted in FIG. 3A, the dispenser can be located upstream of the air seeder cart fan. FIGS. 13A-C illustrate various examples of how this may be done. FIGS. 13A-C illustrate a portion of an air seeder cart that includes a fan 1302, driven by a motor 1304, that directs air flow into an air flow line 1306 (shown in cross-section). An inlet adapter 1308 may be positioned on an inlet cover 1310 of the fan 1302. In the example of FIG. 13A, a dispenser 1310A is connected to the adapter 1308 by a line 1312, which may be, for example, a pipe or hose. The adapter 1308 may have an air flow inlet 1314. Air flow through the adapter 1308 from the air flow inlet 1314 to the fan 1302 entrains the agricultural additive that is fed into the adapter 1308 via the line 1312. Since the entrance to the air flow is upstream of the fan 1302, there is unlikely to be a pressure differential that could potentially prevent the agricultural additive from entering the air flow into the fan 1302 and flowing through the air flow line 1306.

With the positioning of the dispenser upstream of the fan, a pressure differential may exist that may tend to draw agricultural additive into the system. To ensure that this is controlled, the system may be configured so that any uncontrolled flow paths between the container containing the agricultural additive and the adapter 1308 are minimized. FIG. 13B illustrates a variation in which the dispenser 1310B includes a screw auger meter 1320 that controls the delivery of the agricultural additive into the inlet adapter 1308 and reduces the ability of the low pressure caused by the fan 1302 to pull excess agricultural additive into the flow path. This, with the screw auger meter 1320, the low pressure caused by the fan 1302 does not impact the application rate of the agricultural additive.

FIG. 13C illustrates an example that uses a secondary fan and the Venturi effect to direct agricultural additive into the intake side of the fan and prevent the low pressure caused by the fan from pulling in excess agricultural additive. The exemplary dispenser 1310C of FIG. 13C includes a secondary fan 1330 that creates an air flow in a secondary air flow line 1332 that is connected to the adapter 1308. In the illustrated example, an arrangement similar to system 1000 of FIG. 10 is used to feed the agricultural additive into the secondary air flow line 1332. However, this is merely exemplary, and it will be readily understood to a person having ordinary skill in the art that any of the techniques shown in FIGS. 2 and 9-12 could be used for feeding the agricultural additive into the secondary air flow line 1332. In the illustrated example, the secondary air flow line 1332 includes a necking section 1334 that creates a Venturi effect that results in a pressure, P3, that is lower than the ambient air pressure, Pa, at the location where the agricultural additive is introduced, which encourages the agricultural additive that is delivered from the meter 1336 to flow into the secondary air flow line 1332. However, because this low pressure does not communicate with the meter 1136 (due to the delivery pathway 1338 being open to ambient air pressure), there is no impact to the application rate of the agricultural additive.

FIGS. 14A and 14B illustrate an exemplary dispenser system 1400 that dispenses agricultural additive to the air intake 1402 of the fan 1404, which utilizes a screw auger similar to dispenser 1310B of FIG. 13B. The dispenser system 1400 includes an adapter 1406 that is connected to the air intake 1402 of the fan 1404. A dispenser 1408 includes a screw auger 1410 that meters agricultural additive 1412 into the adapter 1406. The screw auger 1410 may be driven by a motor 1414, which in the illustrated example is connected to the screw auger 1410 by a drive belt 1416. As noted above with respective to dispenser 1310B of FIG. 13B, the screw auger 1410 may help ensure that agricultural additive 1412 is not sucked out of the container 1418 of the dispenser 1408. The dispenser may be mounted directly to the fan 1404 or may be mounted to any other suitable support structure.

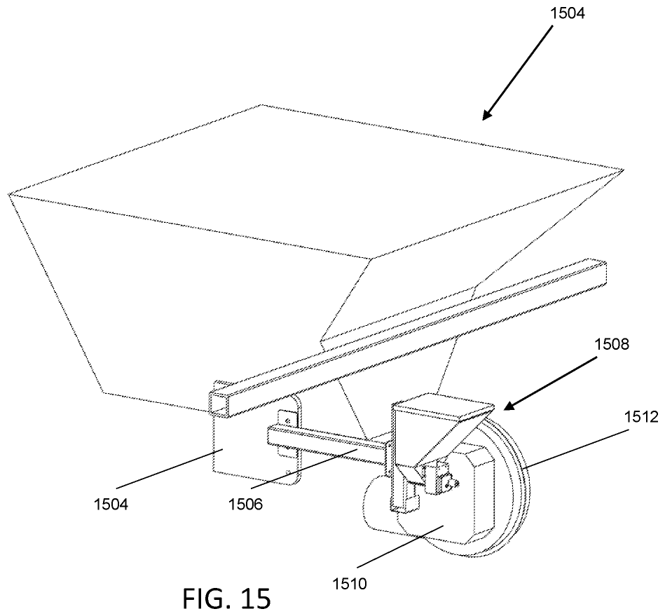

FIG. 15 illustrates an optional manner of mounting a dispenser system, such as dispenser system 1400, to an air seeder cart. Only a rear portion 1502 of an air seeder cart is shown in FIG. 15. The rear portion 1502 includes a tow plate 1504, which is often included in a conventional air seeder cart. A mounting bracket 1506 may be mounted to the tow plate 1504. The dispenser 1508 may be mounted to this bracket 1506. The dispenser 1508 may also be connected to an air intake shroud 1510 of the fan 1512.

It should be understood that the dispensers discussed above with respect to FIGS. 9-15 can include any of the features described herein and can be controlled according to any of the principles described herein. Although the examples discussed above, including those illustrated in FIGS. 9-15, include a single dispenser, other examples may include multiple dispensers. For example, each could dispense a different agricultural additive. For example, multiple dispensers may be positioned along the air flow line and/or may be positioned at the fan air inlet. In this manner, multiple different biological products could be fed into the air seeder simultaneously, each with its own benefit to the planted crop. Alternatively or additionally, the multiple dispensers could be used to dispense different biological products (e.g., inoculums) at different times or at the same time, such as for inoculating more than one crop species at different times or at the same time. Optionally, one or more of the dispensers can dispense seed and/or fertilizer granules with the agricultural additive.

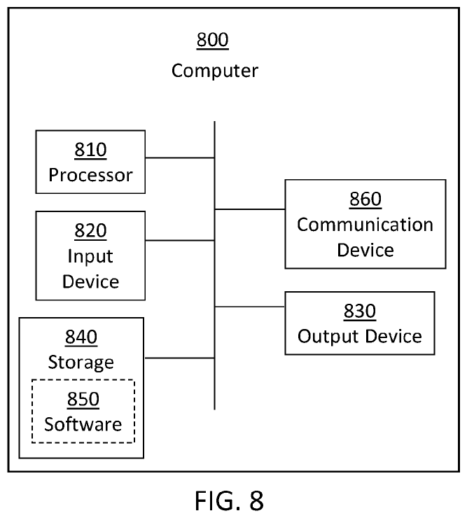

FIG. 8 depicts an example of a computer. Computer 800 can be a component of a system used, for example, as part of a controller configured to receive a signal corresponding to the movement speed of the air seeder cart and to control the rotational velocity of the motor based on the signal, and/or to control the display of the volume of agricultural additive 215 contained within housing 210, as described above. Computer 800 can be used, for example, for controller 230 of FIG. 2.

As shown in FIG. 8, computer 800 can be any suitable type of microprocessor-based device, such as a personal computer; workstation; server; or handheld computing device, such as a phone or tablet. The computer can include, for example, one or more of processor 810, input device 820, output device 830, storage 840, and communication device 860.

Input device 820 can be any suitable device that provides input, such as a touch screen or monitor, keyboard, mouse, or voice-recognition device. Output device 830 can be any suitable device that provides output, such as a touch screen, monitor, printer, disk drive, or speaker.

Storage 840 can be any suitable device that provides storage, such as an electrical, magnetic, or optical memory, including a RAM, cache, hard drive, CD-ROM drive, tape drive, or removable storage disk. Communication device 860 can include any suitable device capable of transmitting and receiving signals over a network, such as a network interface chip or card. The components of the computer can be connected in any suitable manner, such as via a physical bus or wirelessly. Storage 840 can be a non-transitory computer-readable storage medium comprising one or more programs, which, when executed by one or more processors, such as processor 810, cause the one or more processors to execute all or part of any one or more of the methods described herein.

Software 850, which can be stored in storage 840 and executed by processor 810, can include, for example, the programming that embodies the functionality of the present disclosure (e.g., as embodied in the systems, computers, servers, and/or devices as described above). Software 850 can be implemented and executed on a combination of servers such as application servers and database servers.

Software 850 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, Ti or T3 lines, cable networks, DSL, or telephone lines.

Computer 800 can implement any operating system suitable for operating on the network. Software 850 can be written in any suitable programming language, such as C, C++, Java, or Python. In various aspects, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated. For the purpose of clarity and a concise description, features are described herein as part of the same or separate aspects; however, it will be appreciated that the scope of the disclosure includes aspects having combinations of all or some of the features described.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. An agricultural additive dispenser system for delivering an agricultural additive to a stream of air flowing through an air seeder cart toward one or more soil furrows, the system comprising:
a housing for housing the agricultural additive;
a rotational meter connected to the base of the housing to control a delivery rate of the agricultural additive exiting the housing; and
a motor connected to the meter for rotating the meter, wherein the motor can be controlled in correspondence with a movement speed of the air seeder cart such that a delivery rate of the additive into the one or more soil furrows is 5 kilograms or less of agricultural additive per hectare of land.

2. The system of claim 1, wherein the housing comprises a sensor for measuring the volume of agricultural additive contained within the housing.

3. The system of claim 1, wherein the housing is configured for housing a sealed container that contains the additive, and the housing houses a seal-breaking mechanism for breaking a seal of the sealed container.

4. The system of claim 3, wherein the container is thermally insulated.

5. The system of claim 3, further comprising a container-locking mechanism configured to mount and seal the container to the housing.

6. The system of claim 1, wherein the housing is configured for directly adding the additive into the housing.

7-10. (canceled)

11. The system of claim 1, wherein the agricultural additive comprises one or more microbial inoculums.

12-13. (canceled)

14. The system of claim 1, wherein the agricultural additive comprises powder and/or granules.

15-16. (canceled)

17. The system of claim 1, wherein the rotational meter comprises a wheel, an auger, or a worm gear.

18-19. (canceled)

20. The system of claim 1, further comprising a controller configured to receive a signal corresponding to the movement speed of the air seeder cart and to control the rotational velocity of the motor based on the signal.

21. The system of claim 1, wherein the system is configured to be retrofit onto an air seeder cart.

22. An agricultural additive dispenser system for delivering an agricultural additive to a stream of air flowing through an air seeder cart toward one or more soil furrows, the dispenser system comprising:
a housing for housing the agricultural additive;
a rotational meter connected to the base of the housing to control a delivery rate of the agricultural additive exiting the housing;
a motor connected to the meter for rotating the meter, wherein the motor can be controlled in correspondence with a movement speed of the air seeder cart; and
a delivery tip extending beneath the meter for directing the agricultural additive into the stream of air, wherein the delivery tip is configured for extending into the stream of air to reduce the suction of agricultural additive out of the meter and into the stream of air.

23. The system of claim 22, wherein the delivery tip comprises a funnel.

24. The system of claim 22, wherein the delivery tip extends into the stream of air from the upstream side of the meter.

25. The system of claim 22, wherein the housing comprises a sensor for measuring the volume of agricultural additive contained within the housing.

26. The system of claim 22, wherein the housing is configured for housing a sealed container that contains the additive, and the housing houses a seal-breaking mechanism for breaking a seal of the sealed container.

27. The system of claim 26, wherein the container is thermally insulated.

28. The system of claim 26, further comprising a container-locking mechanism configured to mount and seal the container to the housing.

29. The system of claim 22, wherein the housing is configured for directly adding the additive into the housing.

30-33. (canceled)

34. The system of claim 22, wherein the agricultural additive comprises one or more microbial inoculums.

35-36. (canceled)

37. The system of claim 22, wherein the agricultural additive comprises powder and/or granules.

38-39. (canceled)

40. The system of claim 22, wherein the rotational meter comprises a wheel, and auger, or a worm gear.

41-42. (canceled)

43. The system of claim 22, further comprising a controller configured to receive a signal corresponding to the movement speed of the air seeder cart and to control the rotational velocity of the motor based on the signal.

44. The system of claim 22, wherein the system is configured to be retrofit onto an air seeder cart.

45-75. (canceled)

76. A method of delivering agricultural products to a stream of air flowing through an air seeder cart toward one or more soil furrows, the method comprising:
dispensing seed stored in a first dispenser into the stream of air for delivery to the one or more soil furrows; and
dispensing agricultural additive stored in a second dispenser into the stream of air at a rate of 5 kilograms or less of agricultural additive per hectare of land.

77. The method of claim 76, further comprising storing a container in a cold storage unit before installing onto the second dispenser.

78. The method of claim 76, further comprising breaking a seal on the container when the container is installed onto the second dispenser.

79. The method of claim 76, further comprising mounting and sealing the container after installing onto the second dispenser.

80. The method of claim 76, further comprising receiving, at a controller, a signal corresponding to the movement speed of the air seeder cart and controlling the rate at which agricultural additive is dispensed based on the signal.

81-91. (canceled)

92. The method of claim 76, wherein the agricultural additive comprises one or more microbial inoculums.
